(19) United States
(12) Patent Application Publication
(10) Pub. No.: US 2017/0131681 A1
(43) Pub. Date: May 11, 2017

(54) IMAGE OBSERVATION APPARATUS

(71) Applicant: CANON KABUSHIKI KAISHA, Tokyo (JP)

(72) Inventor: Toshiyuki Sudo, Utsunomiya-shi (JP)

(21) Appl. No.: 15/337,702

(22) Filed: Oct. 28, 2016

(30) Foreign Application Priority Data
Nov. 5, 2015 (JP) 2015-217688

(51) Int. Cl. G03H 1/00; F21V 8/00; G03H 1/04; G03H 1/22; H04N 5/225; G02B 23/24

(52) U.S. Cl. CPC G03H 1/0005; H04N 5/2256; G02B 23/2484; G03H 1/0402; G03H 1/041; G02B 23/2461; G03H 1/2286; G02B 6/0008; H04N 2005/2255; G03H 2222/42; G03H 2222/43; G03H 2001/0434; G03H 2223/16; G03H 2270/55

(57) ABSTRACT

The image observation apparatus introduces an object light, which is at least part of an object illumination light emitted from a light source and projected onto an object and which is reflected by the object, through a first optical waveguide to an image sensor, introduces a reference light, which is emitted from the light source and passes through an optical path different from that of the object light, to the image sensor, and records an interference fringe through the image sensor as a hologram. The apparatus forms the recorded hologram on a spatial light modulator and illuminate the modulator with a hologram illumination light corresponding to the reference light to generate a reconstruction light, and causes the reconstruction light entering a second optical waveguide optically equivalent to the first optical waveguide and exiting from the second optical waveguide to form an object reconstructed image.

### BACKGROUND OF THE INVENTION

Field of the Invention

The present invention relates to an image observation apparatus configured to perform image capturing of an object to allow an observer to observe an object reconstructed image, which is suitable for, for example, an endoscope apparatus.

Description of the Related Art

Image observation apparatus like the above mentioned one are widely used as industrial endoscopes or medical endoscopes, each being inserted into a thin lumen and performing image capturing of a subject (object) existing inside the lumen to enable an observation of a subject reconstructed image (object reconstructed image). However, reducing a diameter of the apparatus so as to enable insertion into a thinner lumen makes it difficult, because of area and volume restrictions, to maintain performances of electronic devices constituting the apparatus, in particular that of an image sensor at a high level. Furthermore, reducing the diameter of the apparatus makes it difficult, because of design, manufacturing and assembly restrictions, to maintain qualities of optical elements constituting the apparatus at a high level. Thus, a quality of an acquired image is degraded.

A reference literature: Youngwoon Choi et al., “Scanner-Free and Wide-Field Endoscopic Imaging by Using a Single Multimode Optical Fiber”, PHYSICAL REVIEW LETTERS 109, 203901 (2012) discloses, in order to solve such problems, an endoscope apparatus performing image capturing of an object inside a body using only one multimode optical fiber. This apparatus is provided with no imaging optical system such as a lens and no sensor at its endoscope tip and realizes image information transmission using only one multimode optical fiber whose diameter is several hundred microns.

Description will be made of a principle of the endoscope apparatus disclosed in the above reference literature. This apparatus considers the multimode optical fiber as one scatterer and acquires beforehand “a transmitting matrix” of scattering matrixes expressing light propagation characteristics in the scatterer; the transmitting matrix expresses a propagation characteristic on a transmitting component.

When a near-entrance end surface located on an inside-body side is defined as an OP plane (ξ_{η} plane) and a near-exit end surface located on an outside-body side is defined as an IP plane (xy plane), a relation between the transmitting matrix T, an image row E_{Ip} on the IP plane and an image row E_{OP} on the OP plane is expressed by following expression (1).

E_{IP}(x,y)=T E_{OP}(ξ,η) (1)

Rewriting expression (1) using an inverse matrix T¹ of the transmitting matrix T provides a definition expressed by following expression (2).

E_{OP}(ξ,η)=T⁻¹E_{IP}(x,y) (2)

That is, it is only necessary to acquire the image row on the IP plane (outside-body side near-exit end surface) of the optical fiber and the transmitting matrix T in order to obtain an image on the OP plane (inside-body side near-entrance end surface) of the optical fiber. When the transmitting matrix T is considered as a matrix acquired by converting an object image row E_{OP}(θ_{ξ}, θ_{η}, ξ, η) obtained by illuminating an object on the OP plane with a collimated light in a θ_{ξ}, θ_{η} direction, using an image converting matrix E_{fiber} for an image conversion from the OP plane to the IP plane by fiber propagation, a relation expressed by following expression (3) is established.

$$T ( x , y , ξ , η ) = {\sum }_{{θ}_{ξ} , {θ}_{η}} {E}_{fiber} ( x , y ; {θ}_{ξ} , {θ}_{η} ) {E}_{OP} ( {θ}_{ξ} , {θ}_{η} ; ξ , η ) \qquad ( 3 )$$

The relation of expression (3) is useful for experimentally acquiring the transmitting matrix T. Specifically, causing the coherent light to actually sequentially enter the optical fiber from its inside-body side at an incident angle of θ_{ξ}, θ_{η} enables acquiring an image row having a light intensity distribution formed on the outside-body side near-exit end surface IP (xy plane) at each time when the coherent light enters. From expression (3), when the object image row E_{OP} has a uniform distribution (when the collimated light whose incident angle is θ_{ξ}, θ_{η} directly enters the optical fiber), the image converting matrix E_{fiber} for the image conversion from the OP plane to the IP plane by the fiber propagation directly becomes the transmitting matrix T. Acquiring thus the light propagation characteristic of the multimode optical fiber once enables acquiring a reflected light intensity distribution of the object placed at the inside-body side near-entrance end surface OP using the inverse matrix calculation of expression (2) and the integration calculation of expression (3) (averaging of speckle images).

The apparatus disclosed in the above reference literature can realize an endoscope apparatus whose diameter is extremely small. However, the disclosed apparatus involves the following problems (reasons for generation of these problems will be described later).

1. The calculations of expressions (2) and (3) need a large amount of image processing calculations, so that a long time is required for acquiring an object image, which makes it impossible to perform real-time display required by the endoscope apparatus.

2. In order to acquire beforehand the light propagation characteristic of the optical fiber, it is necessary to perform a measurement with multiplexing of the incident angle θ_{ξ}, θ_{η} to the optical fiber, which requires a long time for calculation.

3. A difference of a state of the optical fiber in observing the object inside the body from that in acquiring beforehand the light propagation characteristic of the optical fiber changes the transmitting matrix T, which makes it impossible to produce (reconstruct) a correct object image by the above calculations.

### SUMMARY OF THE INVENTION

The present invention provides an image observation apparatus capable of reducing a time required for calculations for reconstructing an image of an object captured through an optical waveguide such as an optical fiber to allow real-time observation of the object image.

The present invention provides as an aspect thereof an image observation apparatus including a light source, a first optical waveguide, an image sensor configured to perform photoelectric conversion, a second optical waveguide, and a spatial light modulator configured to modulate light. The apparatus is configured to introduce an object light, which is at least part of an object illumination light emitted from the light source and projected onto an object and which is reflected by the object, through the first optical waveguide to the image sensor; introduce a reference light, which is emitted from the light source and passes through an optical path different from that of the object light, to the image sensor; record an interference fringe, which is formed by the object light and the reference light, through the image sensor as a hologram; form the recorded hologram on the spatial light modulator and illuminate the spatial light modulator with a hologram illumination light corresponding to the reference light to generate a reconstruction light; and cause the reconstruction light, which enters the second optical waveguide optically equivalent to the first optical waveguide and exits from the second optical waveguide, to form an object reconstructed image.

Further features and aspects of the present invention will become apparent from the following description of exemplary embodiments with reference to the attached drawings.

### BRIEF DESCRIPTION OF THE DRAWINGS

FIG. 1 illustrates a configuration of an image observation apparatus (in recording a hologram) of Embodiment 1 of the present invention.

FIG. 2 illustrates a configuration of the image observation apparatus (in reconstructing a subject reconstructed image) of Embodiment 1.

FIG. 3 illustrates an image observation apparatus of Embodiment 2 of the present invention.

FIG. 4 illustrates an image observation apparatus of Embodiment 3 of the present invention.

FIG. 5 illustrates an image observation apparatus of Embodiment 4 of the present invention.

FIG. 6 illustrates an image observation apparatus of Embodiment 5 of the present invention.

FIG. 7 illustrates holographic recording through a first optical waveguide that is bent.

FIG. 8 illustrates holographic reconstructing through a second optical waveguide whose bending state is different from that in the recording.

FIG. 9 illustrates a configuration for detecting a bending state of the first optical waveguide.

FIG. 10 illustrates a configuration for detecting a bending state of the second optical waveguide.

### DESCRIPTION OF THE EMBODIMENTS

Exemplary embodiments of the present invention will hereinafter be described with reference to the accompanying drawings.

### Embodiment 1

### (Apparatus Configuration)

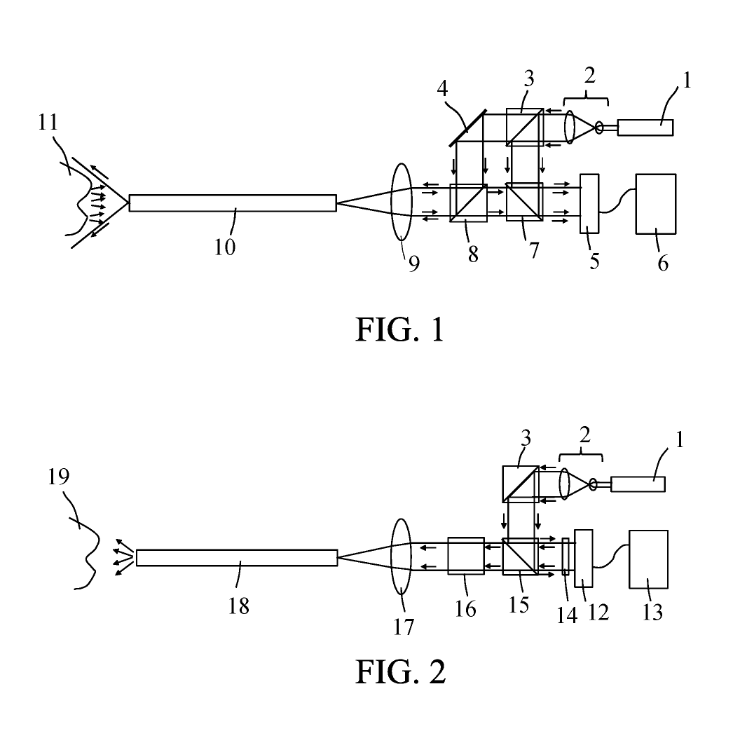

FIGS. 1 and 2 illustrate a basic configuration of an endoscope apparatus as an image observation apparatus that is a first embodiment (Embodiment 1) of the present invention. FIG. 1 illustrates a configuration of the endoscope apparatus in recording a hologram indicating object information, and FIG. 2 illustrates a configuration of the endoscope apparatus in forming (that is, in reconstructing) a subject reconstructed image (object reconstructed image). In FIGS. 1 and 2, reference numeral 1 denotes a laser light source, and 2 a beam expander. Reference numerals 3, 7, 8 and 15 denote beam splitters, 4 a mirror, 5 an image sensor, and 6 an image acquirer for the image sensor 6. Reference numeral 9 denotes a first coupling optical system, 10 a first optical waveguide, and 11 a subject (object). Reference numeral 12 denotes a spatial light modulator (SLM), 13 a spatial light modulator driver, and 14 a phase adjuster for the spatial light modulator 12. Reference numeral 16 denotes an optical path difference adjusting block, 17 a second coupling optical system, 18 a second optical waveguide, and 19 a subject reconstructed image.

The endoscope apparatus of this embodiment is inserted into a thin lumen to allow an observer to observe an inside of the lumen, so that it aims especially to make its diameter as small as possible.

Therefore, the endoscope apparatus uses, as the first and second optical waveguides 10 and 18, optical fibers.

However, a singlemode optical fiber is not suitable for the endoscope apparatus because the singlemode fiber only can allow a light component near an optical axis, which is part of a reflected light from a subject, to propagate therein. Thus, the endoscope apparatus of this embodiment uses, as the first and second optical waveguides 10 and 18, multimode optical fibers.

The endoscope apparatus of this embodiment performs, using a holography principle, recording of holograms and reconstruction of subject reconstructed images. First, description will be made of a method of recording the holograms with referring to FIG. 1. A coherent light emitted from the laser light source 1 is converted by the beam expander 2 into a collimated light beam having a predetermined diameter and then is divided into two lights respectively used as an object light and a reference light for the recording of the holograms.

An object illumination light from which the object light is generated passes through an optical path indicated by reference numerals 1→2→3→4→8→9 in FIG. 1 and then passes through the first optical waveguide to be projected onto (that is, to illuminate) the subject 11. The object illumination light enters the first optical waveguide 10 from its one end opposite to a subject side end (object side end), proceeds toward the subject 11 (that is, in an object illumination direction) and exits from the subject side end to be projected onto the subject 11.

Of this object illumination light, a light component reflected at a surface of the subject 11 and re-entering the first optical waveguide 10 to propagate in a direction opposite to the object illumination direction becomes the object light. That is, the object light is at least part of the object illumination light. The object light from the subject passes through an optical path indicated by reference numerals 10→9→8→7→5 and then reaches a sensor surface of the image sensor 5. The object light enters the first optical waveguide 10 from its subject side end and exits from the other end opposite to the subject side end to reach the sensor surface of the image sensor 5.

On the other hand, the reference light passes through an optical path indicated by reference numerals 1→2→3→7→5, which does not include the first optical waveguide 10, that is, an optical path different from the optical path of the object light, to reach the sensor surface of the image sensor 5. On the sensor surface, the object light and the reference light interfere with each other to form a hologram interference fringe. The image sensor 5 photoelectrically converts this hologram interference fringe to record an intensity distribution of the hologram interference fringe to the image acquirer 6 connected to the image sensor 5. Thereby, the hologram is recorded.

Next, description will be made of a method of reconstructing the subject reconstructed image with referring to FIG. 2. In the reconstruction, the endoscope apparatus of this embodiment reconstructs, on the spatial light modulator 12, the hologram (interference fringe) recorded by the above-described recording method and illuminates the hologram with a light corresponding to the reference light used in the recording, that is, a hologram illumination light whose light conditions such as its wavelength and its intensity are identical to those of the reference light, thereby reconstructing the object light. The hologram illumination light passes through an optical path indicated by reference numerals 1→2→3→15→14→12 in FIG. 2 and then reaches the spatial light modulator 12.

The hologram interference fringe formed on the spatial light modulator 12 modulates an amplitude and a phase of the hologram illumination light to generate a hologram reconstruction light. The hologram reconstruction light has wavefronts identical to those of the original object light and passes through an optical path indicated by reference numerals 12→14→15→16→17→18 to form the subject reconstructed image 19 corresponding to the original subject 11. The hologram reconstruction light enters the second optical waveguide 18 from its entrance end and exits from its exit end opposite to the entrance end to form the subject reconstructed image 19. This subject reconstructed image 19 is observed by the observer, which enables observation of the subject 11 present inside the body.

In order to correctly reconstruct the subject reconstructed image, it is necessary to make the optical paths in the recording and in the reconstruction optically equivalent to each other. Therefore, the above optical elements used in the recording and in the reconstruction are configured such that their arrangement, specification and performance are mutually identical. Specifically, the beam splitters 7 and 15, the beam splitter 8 and the optical path difference adjusting block 16, the first and second coupling optical systems 9 and 17 and the first and second optical waveguides 10 and 18 are respectively optically equivalent to each other. Although this embodiment uses as the spatial light modulator 12 a reflective spatial light modulator, a transmissive spatial light modulator may be used.

### (Integration of Recording System and Reconstruction System)

As described above, in the apparatus of this embodiment, the optical path in recording the hologram (hereinafter referred to as “a recording system”) and the optical path in reconstructing the subject reconstructed image (hereinafter referred to as “a reconstruction system”) are optically equivalent to each other. Therefore, integrating the recording and reconstruction systems with each other by sharing part of the above-described optical elements enables reducing a number of the optical elements and improving accuracy.

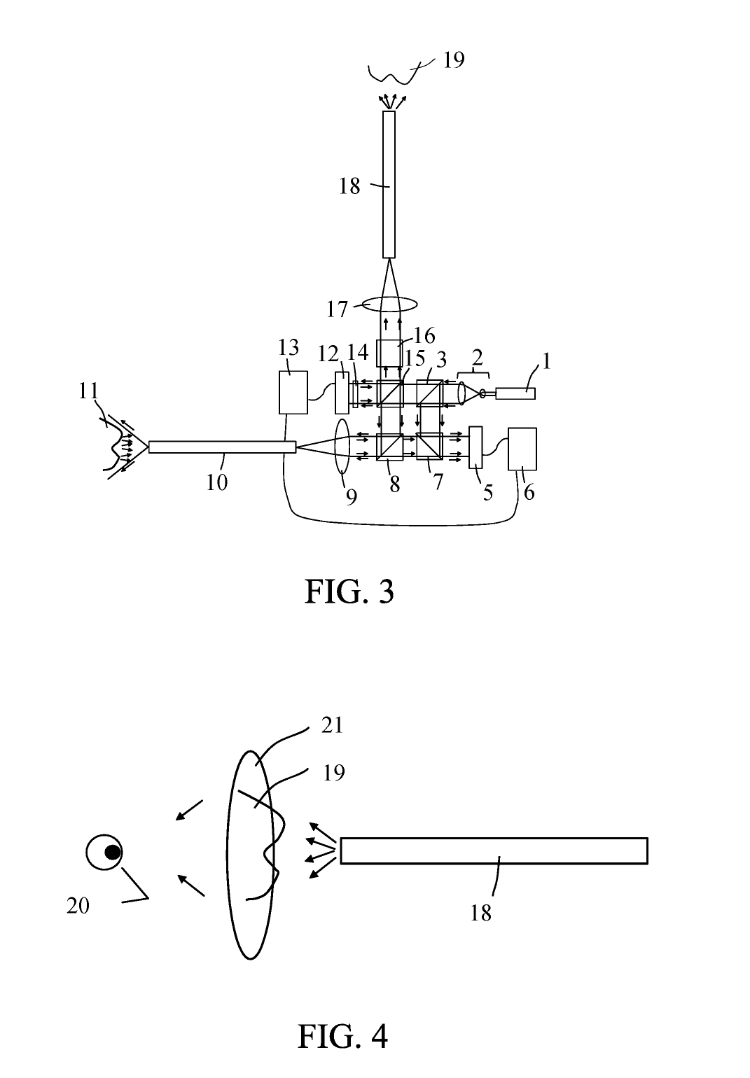

FIG. 3 illustrates an example of such an integration configuration. In this configuration, the recording and reconstruction systems share the laser light source 1, the beam expander 2 and the beam splitter 3. Of the light emitted from the laser light source 1 and entering the beam splitter 3, a reflected light is used as the reference light in the recording, and a transmitted light thereof is used as the hologram illumination light in the reconstruction. Of the transmitted light exiting from the beam splitter 3 and entering the beam splitter 15, a reflected light is used as the object illumination light in the recording, and a transmitted light is used as the hologram illumination light in the reconstruction. Furthermore, the hologram reconstruction light modulated by the spatial light modulator 12 and entering the beam splitter 15 is reflected by the beam splitter 15 to proceed toward the second optical waveguide 18. On the other hand, of the reflected light exiting from the beam splitter 15 and entering the beam splitter 8, a reflected light is used as the object illumination light in the recording. The object light exiting from the first optical waveguide 10 and entering the beam splitter 8 is transmitted through the beam splitter 8 to proceed toward the image sensor 5.

Employing such an integrated configuration enables realizing a compact endoscope apparatus.

### (Field Lens and Concave-Convex Inversion)

This embodiment may involve two problems in observing the subject reconstructed image. First, the apparatus of this embodiment allows the observer to observe the subject reconstructed image formed by an exit light from an optical waveguide (optical fiber) having an extremely small diameter. In observing the subject reconstructed image, the observer observes a divergent light from an approximate point light source and thereby only can observe the subject reconstructed image formed in an area connecting between a pupil of an eye of the observer and an exit end of the optical fiber.

In order to solve this problem, this embodiment uses, as illustrated in FIG. 4, a field lens 21 disposed near the subject reconstructed image 19 to cause the hologram reconstruction light forming the subject reconstructed image distant from an optical axis of the optical fiber to also enter the eye of the observer. In this configuration, providing a scattering characteristic as a screen effect on a surface or an inside of the field lens 21 to an extent that does not disturb a three-dimensional imaging of the subject reconstructed image 19 enables more surely preventing a light amount reduction of the subject reconstructed image distant from the optical axis of the optical fiber.

Second, there is, as a problem, a concave-convex inversion of the observed subject reconstructed image 19. As understood from a comparison of FIGS. 1 and 2, when the hologram (interference fringe) formed by the object light as the reflected light from the subject 11 is recorded, the object light proceeds from the subject 11 to right in FIG. 1 in the first optical waveguide 10. On the other hand, the hologram reconstruction light forming the subject reconstructed image 19 proceeds to left in the second optical waveguide 18, so that the observer has to observe the subject reconstructed image 19 from its left side. Such an observation causes the observer to recognize the subject reconstructed image 19 as an image whose concave and convex are inverted with respect to the actual subject 11.

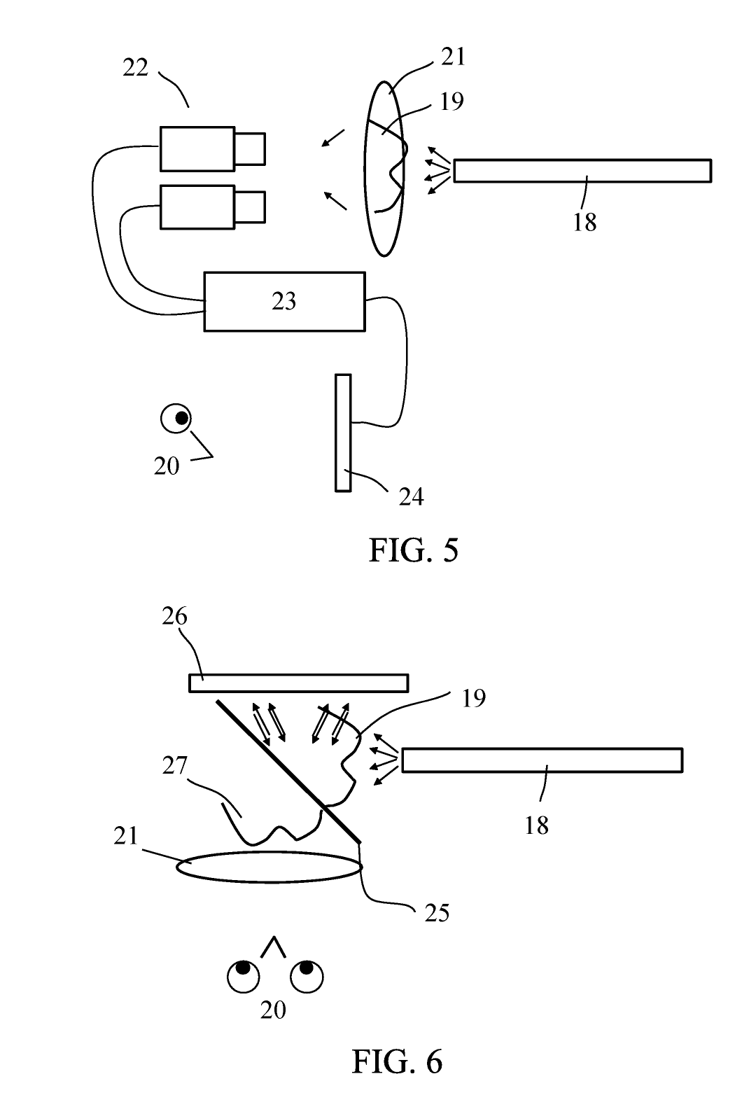

Thus, this embodiment performs image capturing of the subject reconstructed image 19 with an image capturer 22 as illustrated in FIG. 5, performs image processing, in an image inputter/outputter 23, on image data acquired by the image capturing and displays the image data subjected to the image processing on a display device 24. In order to maintain a three-dimensional characteristic of the original subject reconstructed image 19, the image capturer 22 is desirable to be a stereo image capturer configured to acquire right and left parallax images mutually having a parallax. In addition, in order to display the subject reconstructed image 19 correctly as a three-dimensional image, the display device 24 is desirable to be a stereo display device configured to perform directional-view display for observer's right and left eyes, and the image inputter/outputter 23 is desirable to perform a concave-convex inverting process on the three-dimensional image in its signal processing. Specifically, it is desirable to capture the subject reconstructed image 19 with the stereo image capturer 22 having right and left lenses and to display, on the display device 24 as the stereo display device, the right and left parallax images whose right and left are interchanged. This configuration enables the observer to observe the subject reconstructed image 19 whose concave and convex are identical to those of the original subject 11. However, this configuration often provides, as an image directly observed by the observer, a too small subject reconstructed image 19 having the same size as that of the original subject 11. Thus, this embodiment uses, as the display device 24, an appropriate-sized display device capable of displaying a three-dimensional image enlarged with respect to the subject reconstructed image 19.

Another method for solving the concave-convex inversion illustrated in FIG. 6 may be employed. This method projects the hologram reconstruction light forming the subject reconstructed image 19 onto a retroreflective screen 26 via a half mirror 25. This method performs a concave-convex inversion of the subject reconstructed image 19 and enables the observer to observe, through a field lens 21, a subject reconstructed image 27 whose concave and convex are correct.

### Embodiment 2

### (Solution for Bend of Optical Fiber)

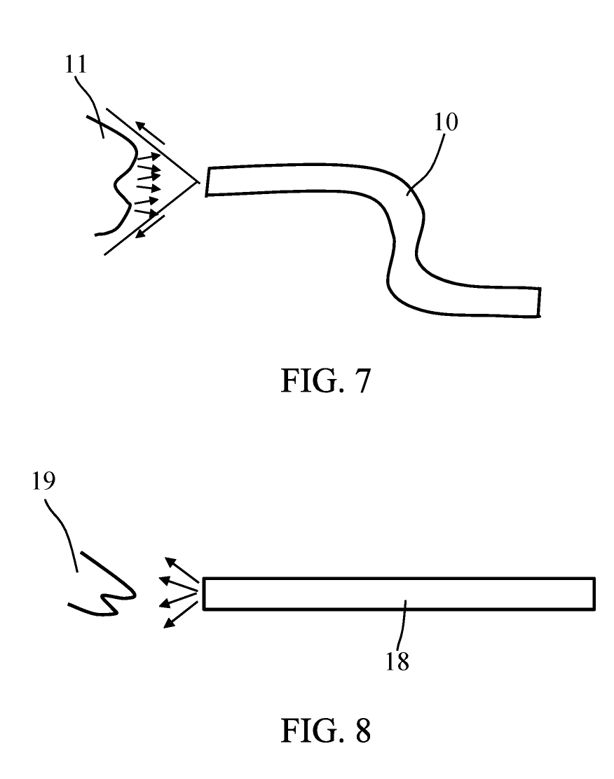

As described in Embodiment 1, it is necessary in the endoscope apparatus performing the recording of the hologram and the reconstruction of the subject reconstructed image according to the holography principle that the recording system and the reconstruction system be optically equivalent to each other. However, in the case of using, like the endoscope apparatus of Embodiment 1, a small diameter multimode optical fiber as the optical waveguide, the first optical waveguide 10 whose shape is changed by being inserted into a body in the recording and the second optical waveguide 18 used in the reconstruction are mutually different optical systems, which may make it impossible to provide a correct subject reconstructed image 19. FIGS. 7 and 8 illustrate this problem.

When the hologram is recorded in a state where the first optical waveguide 10 is bent as illustrated in FIG. 7, performing the reconstruction using the second optical waveguide not bent as illustrated in FIG. 8 provides a subject reconstructed image 19 different from the original subject 11. This embodiment uses, as a method for solving this problem, a fiber displacement sensor disclosed in Reference Literature 1 and Reference Literature 2.

(Reference Literature 1) Jumpei Arata, et al., “Development of a Back Bone Shape Allay Force Sensor Using Optical Fiber”, Journal of Japan Society of Computer Aided Surgery, Vol. 14, No. 4 (2012)

(Reference Literature 2) Japanese Patent Laid-Open No. 2008-173397

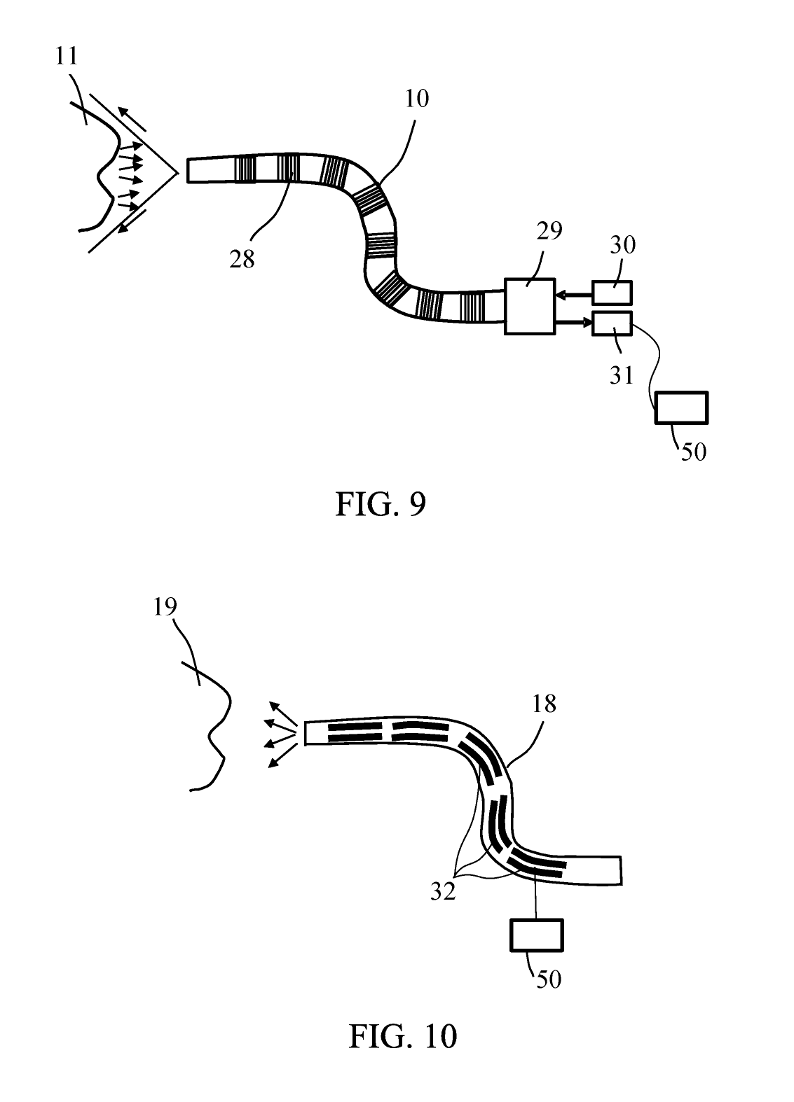

A specific method will be described with referring to FIGS. 9 and 10. First, this embodiment uses, as a bend detector for detecting a bending state (that is, a shape) of the first optical waveguide 10 in recording the hologram, a fiber bragg grating (hereinafter referred to as “an FBG”).

The FBG has a diffraction grating structure (periodic diffraction gratings) preformed in a core portion inside an optical fiber and uses its characteristic that the diffraction grating structure reflects only a light component having a specific wavelength (bragg wavelength), which is part of an entering light, and transmits other wavelength light components to detect a displacement state of the optical fiber. When a temperature of the FBG rises or an external force is applied to the FBG and thereby the FBG expands or extends, intervals between the diffraction gratings are changed and thereby the bragg wavelength is also changed, so that a displacement amount of the optical fiber can be detected depending on a variation amount of the bragg wavelength. Accordingly, providing such FBGs whose bragg wavelengths are mutually different at multiple portions in one optical fiber and performing a spectral analysis on a returning light of a wideband entering light enables measuring the displacement state of the optical fiber.

This embodiment provides multiple FBGs 28 at hatched portions in the first optical waveguide (optical fiber) 10 as illustrated in FIG. 9 and introduces an entering light from a wideband light source 30 to the first optical waveguide 10 through a coupler 29. This embodiment further provides a spectral detector 31 configured to detect a spectral characteristic of a reflected (returning) light from the first optical waveguide 10. Since the FBGs 28 have mutually different bragg wavelengths, mutually different spectral characteristics of the reflected light are detected depending on a displaced portion in the first optical waveguide 10, which enables detecting a displacement state of the first optical waveguide 10.

Data of the detected displacement state of the first optical waveguide 10 is sent to a recorder/controller 50 to be used for controlling a bending state of the second optical waveguide 18 used in the reconstruction. This embodiment uses, in order to perform such a bending state control, a soft actuator disclosed in Reference Literature 3.

(Reference Literature 3) Hiroyuki Okamura and Hirochika Inoue, “Research for the future Program-Micro-mechatronics and soft mechanics”, Journal of the Robotics Society of Japan, 18. 8 (2000)

The soft actuator, which is formed of a soft material such as a conductive polymeric material or a conductive gel, is provided to technologically mimic a body's muscle. That is, the soft actuator is an artificial muscle. As illustrated in FIG. 10, on a surface of the second optical waveguide 18 used in the reconstruction, soft actuators 32 divided so as to form multiple joints like muscles that move a finger or an arm are attached. All of the soft actuators 32 are connected to a recorder/controller 50. The recorder/controller 50 controls these soft actuators 32 such that the bending state of the second optical waveguide 18 matches or approximates that of the first optical waveguide 10 in the recording.

Such a bending state control enables the recording system and the reconstruction system to be optically equivalent optical systems having no (or almost no) optical difference therebetween, which enables providing a correct subject reconstructed image 19.

### Effects of Embodiments

The above-described embodiments provide the following effects.

First, Embodiment 1 can realize an endoscope apparatus capable of performing image capturing of an inside of a body using only one multimode optical fiber whose diameter is extremely small.

Second, although conventional apparatuses cannot perform a real-time display in reconstructing a subject reconstructed image because the apparatuses reconstruct the image with a large amount of repetitive image processing calculations, Embodiment 1 can perform a real-time display without performing such calculations.

Third, Embodiment 1 can solve the problem of the concave-convex inversion of the subject reconstructed image and the problem that the subject reconstructed image is too small in size.

Fourth, Embodiment 2 can control the bending state of the optical fiber (second optical waveguide) in reconstructing the subject reconstructed image, which enables, irrespective of the bending state of the optical fiber (first optical waveguide) in recording the hologram, providing a correct subject reconstructed image.

As described above, the above-described embodiments reduce a time required for calculation for reconstructing an image (object reconstructed image) of an object captured through a small diameter optical waveguide such as a multimode optical fiber to enable a real-time observation of the object reconstructed image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-217688, filed on Nov. 5, 2015, which is hereby incorporated by reference herein in its entirety.

What is claimed is:

1. An image observation apparatus comprising:
a light source;
a first optical waveguide;
an image sensor configured to perform photoelectric conversion;
a second optical waveguide; and
a spatial light modulator configured to modulate light,
wherein the apparatus is configured to:
introduce an object light, which is at least part of an object illumination light emitted from the light source and projected onto an object and which is reflected by the object, through the first optical waveguide to the image sensor;
introduce a reference light, which is emitted from the light source and passes through an optical path different from that of the object light, to the image sensor;
record an interference fringe, which is formed by the object light and the reference light, through the image sensor as a hologram;
form the recorded hologram on the spatial light modulator and illuminate the spatial light modulator with a hologram illumination light corresponding to the reference light to generate a reconstruction light; and
cause the reconstruction light, which enters the second optical waveguide optically equivalent to the first optical waveguide and exits from the second optical waveguide, to form an object reconstructed image.

2. An image observation apparatus according to claim 1, wherein the apparatus is configured to cause the object illumination light to enter the first optical waveguide from its one end opposite to its object side end and to exit from the object side end toward the object.

3. An image observation apparatus according to claim 1, wherein the first and second optical waveguides are each a multimode optical fiber.

4. An image observation apparatus according to claim 1, wherein the apparatus is configured to cause an image capturer to perform image capturing of the object reconstructed image and to cause a display device to display image data acquired by the image capturing.

5. An image observation apparatus according to claim 4, wherein:
the image capturer is a stereo image capturer configured to acquire right and left parallax images mutually having a parallax;
the display device is a stereo display device configured to perform directional-view display for observer's right and left eyes and to display the right and left parallax images whose right and left are interchanged.

6. An image observation apparatus according to claim 1, wherein the apparatus is configured to project the reconstruction light onto a retroreflective screen to display the object reconstructed image.

7. An image observation apparatus according to claim 1, further comprising:
a bend detector configured to detect a bending state of the first optical waveguide when the hologram is recorded; and
a controller configured to perform a control to cause a bending state of the second optical waveguide to match or approximate the bending state of the first optical waveguide detected by the bend detector.

8. An image observation apparatus according to claim 7, wherein the bend detector uses a fiber bragg grating.
